(19) United States
(12) Patent Application Publication
(10) Pub. No.: US 2016/0102020 A1
(43) Pub. Date: Apr. 14, 2016

(54) LINOLEUM COMPOSITION WITH HYDROPHOBIC ADDITIVE

(71) Applicant: ARMSTRONG WORLD INDUSTRIES, INC., Lancaster, PA (US)

(72) Inventors: Matthew S. Myers, Lititz, PA (US); Kean M. Anspach, Quarryville, PA (US); Mary Kate Davies, Stevens, PA (US); Brent L. Stoll, Lititz, PA (US); Phi-Oanh R. Pham, Lancaster, PA (US); David R. Wilcox, Mountville, PA (US); Jens Ehlers, Hamminkein (DE); Marika Zobel, Hude (DE); Arne Berkemeier, Diepholz (DE); Juergen Behrens, Harpstedt (DE)

(21) Appl. No.: 14/714,311

(22) Filed: May 17, 2015

Related U.S. Application Data
(60) Provisional application No. 62/062,468, filed on Oct. 10, 2014.

(51) Int. Cl. C04B 24/00; B32B 13/14; C04B 14/30; C04B 16/02; C04B 14/28; D06N 1/00; B32B 13/04

(52) U.S. Cl. CPC C04B 24/00; D06N 1/00; B32B 13/14; B32B 13/04; C04B 16/02; C04B 14/28; C04B 14/30; B32B 2250/02; B32B 2305/38; B32B 2307/73; B32B 2471/00; C04B 2111/60

(57) ABSTRACT

A linoleum composition comprising Bedford cement as a binder, wood flour as a filler, and wax in an amount effective to provide the wood flour filler with hydrophobic properties.

### CROSS-REFERENCE TO RELATED APPLICATION

This application claims the benefit of U.S. Provisional Patent Application No. 62/062,468 filed on Oct. 10, 2014. The disclosure of the above application is incorporated herein by reference.

### FIELD OF THE DISCLOSURE

This present disclosure relates to linoleum compositions.

### BACKGROUND

It is well known to produce linoleum and the production of linoleum has been known for many years. Linoleum is typically manufactured using wood flour as a filler. Wood flour expands in volume when water is absorbed by the wood flour, and correspondingly shrinks in volume when the wood flour dries. Such volume changes resulting from the fluctuating water content of wood flour makes the linoleum inherently dimensionally unstable. Linoleum tiles can curl and shrink in dry ambient environments, and buckle and expand in moist ambient environments. Changes in atmospheric humidity can introduce undesired excessive dimensional instability into a linoleum composition, which is most problematic when the linoleum composition is utilized in the form of an assembly of individual tiles.

It is known in the art of manufacturing linoleum to try to minimize water absorption by modifying the structure of the linoleum. For example, engineered scrims, which comprise a backing layer of fabric, and edge details have been provided to minimize the natural tendency of a wood based product to absorb moisture. However, such modifications are not very effective since they do not solve the primary cause of the dimensional instability, which is the presence in the linoleum composition of wood flour having water sorption properties.

There is a need in the art for a linoleum composition which can produce tiles of high dimensional stability, which can exhibit reduced expansion/contraction and reduced curling/warping as compared to known linoleum compositions.

The invention at least partly aims to meet this need.

### SUMMARY

A first aspect of the present invention provides a linoleum composition comprising Bedford cement as a binder, wood flour as a filler, and a wax, for example paraffin wax, in an amount effective to provide the wood flour filler with hydrophobic properties. Other suitable waxes include natural waxes, such as carnauba wax, beeswax, and montan wax.

Optionally, the wax is present in an amount of from 0.1 to 1 wt %, further optionally from 0.1 to 0.6 wt %, based on the weight of the linoleum composition. In a particular embodiment, the wax is present in an amount of about 0.3 wt % based on the weight of the linoleum composition.

Optionally, the wax has a congealing point of from 54 to 56 ° C. measured according to DIN ISO 2207. Optionally, the wax has an oil content of less than or equal to 0.5 wt % measured according to DIN ISO 2908. Optionally, the wax has a penetration of from 16 to 20 measured according to DIN ISO 51579. The wax may provide any combination of these properties.

Optionally, the wood flour is present in an amount of from 15 to 45 wt %, further optionally from 18 to 42 wt %, based on the weight of the linoleum composition. In a particular embodiment, the wood flour is present in an amount of about 40 wt % based on the weight of the linoleum composition.

Optionally, the wood flour has a particle size distribution of 40 to 90 wt %, based on total weight of the wood flour, of 80 μm to 160 μm particles and 10 to 50 wt % of less than 80 μm particles. Preferred has a particle size distribution of 50 to 85 wt %, based on total weight of the wood flour, of 80 μm to 160 μm particles and 10 to 30 wt % of less than 80 μm particles. The particle size is determined using a vibrational sieve.

Optionally, the linoleum composition further comprises limestone in an amount of from 5 to 40 wt %, based on the weight of the linoleum composition. In a particular embodiment, the limestone is present in an amount of from 5 to 30 wt %, based on the weight of the linoleum composition. In another embodiment, the limestone is present in an amount of from 20 to 30 wt % based on the weight of the linoleum composition.

Optionally, the linoleum composition comprises a binder, typically referred to as the Bedford cement, is present in an amount of from 30 to 50 wt %. In a particular embodiment, the Bedford cement is present in an amount of from 35 to 40 wt % based on the weight of the linoleum composition. In another embodiment, the Bedford cement is present in an amount of about 30 wt % based on the weight of the linoleum composition. In another embodiment, the Bedford cement is present in an amount of about 40 wt % based on the weight of the linoleum composition.

Optionally, the linoleum composition further comprises a flame retardant, such as aluminium trihydrate (ATH), in an amount of from 5 to 15 wt % based on the weight of the linoleum composition.

Optionally, the linoleum composition further comprises one or more pigments in an amount of up to 5 wt % based on the weight of the linoleum composition.

Optionally, the linoleum composition further comprises zinc oxide in an amount of from 0.1 to 1 wt % based on the weight of the linoleum composition.

Optionally, limestone or wood can be replaced by cured and scrapped linoleum, such as recycled linoleum products.

A second aspect of the present invention provides a flooring material comprising the linoleum composition of the invention.

Typically, the flooring material is a layer element selected from a tile, sheet, and web.

Optionally, the linoleum composition is carried on a carrier scrim material located at a rear major surface of the flooring layer. The scrim may be composed of fabric, such as a nonwoven or woven fabric. The scrim may be composed of natural fibres, such as jute, or another material or mixture of materials. Optionally, the carrier scrim material comprises polymer fibers, such as polyester, e.g., polyethylene terephthalate, polyamide, e.g., nylon 6, and polyolefin, e.g., polypropylene or polyethylene. Optionally, the carrier scrim material comprises fiberglass.

Optionally, the carrier scrim material comprises a mixture of polymer weft fibres and glass warp fibres. Optionally, the weft and warp fibres have a force per unit length ratio within a range of from 5:2 to 5:5 preferred 5:3.5 to 5:4.5. Optionally, the polymer fibres comprise at least one of polyester fibres, such as polyethylene terephthalate (PET) fibres.

Optionally, a wear layer, such as a polyurethane resin layer, covers a front major surface of the flooring material. Optionally, a suitable wear layer comprises polyurethane or polyester, and the layer is formed from a U.V. curable composition. The wear layer has a thickness of from 10 to 30 microns.

In some embodiments, the linoleum composition of the flooring material has a thickness of from 1 mm to 6 mm, preferably 1.5 to 5 mm, more preferably 1.8 to 4 mm.

The flooring material of the present invention can be a one-layer or multilayer flooring material. Optionally, the flooring material comprises a lower layer of a first linoleum composition and an upper layer of a second linoleum composition, the lower and upper layers being bonded together at an interface therebetween, and at least one or both of the lower and upper layers comprising the linoleum composition of the invention. Optionally, the two layers can be bonded together with an adhesive typically used for flooring materials, such as acrylic or polyester pressure sensitive adhesives. When the two layers comprise linoleum compositions, an extraneous adhesive may not be required.

Optionally, the first linoleum composition of the lower layer comprises the linoleum composition of the invention and/or the upper layer of the second linoleum composition comprises the linoleum composition of the invention.

In one embodiment, the upper layer of the second linoleum composition is substantially free of a wax. In another embodiment, the upper layer of the second linoleum composition comprises the linoleum composition of the invention.

Optionally, when the flooring material has two layers, the lower layer has a thickness of from 0.5 to 3 mm, preferably 0.6 to 2.5 mm, more preferably 0.7 to 2 mm, including scrim, and the upper layer has a thickness of 0.5 to 4 mm, preferably 0.6 to 3, more preferably 0.7 to 2.5 mm.

A third aspect of the present invention provides the use of a wax, e.g., paraffin wax, to increase the dimensional stability of a linoleum flooring material composed of a linoleum composition comprising Bedford cement as a binder and wood flour as a filler.

The present invention is at least partly predicated on the finding by the present inventors that the incorporation of a wax as a hydrophobic filler in a linoleum composition comprising wood flour can reduce the rate of water sorption into and out of the linoleum composition. This in turn can reduce the expansion and shrinkage of a linoleum tile when subjected to fluctuating moisture content in an ambient environment. The resultant tile can have high dimensional stability and reduced curling of the edges of the tile.

Furthermore, it has been found that the incorporation of the wax into the linoleum composition comprising wood flour in accordance with the present invention allows the linoleum composition to be readily coated, on the decorative upper face of the tile, with high performance protective, wear-resistant and/or aesthetically appealing coatings, providing high adhesion between the coating and the linoleum composition substrate. It has been also found that the incorporation of the wax into the linoleum composition comprising wood flour in accordance with the present invention does not interfere with applying a decorative printing, e.g., gravure or ink jet printing, on the exposed linoleum surface of the flooring product.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### DETAILED DESCRIPTION

The following description of the preferred embodiment(s) is merely exemplary in nature and is in no way intended to limit the invention, its application, or uses.

As used throughout, ranges are used as shorthand for describing each and every value that is within the range. Any value within the range can be selected as the terminus of the range.

The present invention provides a linoleum composition.

The linoleum composition comprises Bedford cement as a binder. As is well known in the art of manufacturing linoleum compositions, Bedford cement is a binder which typically comprises partially oxidized linseed oil. The Bedford cement may also include at least one other rosin as a tackifier, for example dammar rosin or balsam rosin

The Bedford cement is typically present in an amount of from 30 to 50 wt %. In a particular embodiment, the Bedford cement is present in an amount of from 35 to 45 wt % based on the weight of the linoleum composition. In a particular embodiment, the Bedford cement is present in an amount of about 35 wt % based on the weight of the linoleum composition. In another embodiment, the Bedford cement is present in an amount of about 40 wt % based on the weight of the linoleum composition.

The linoleum composition further comprises at least one filler. In this invention, the linoleum composition comprises wood flour as a filler. The wood flour is typically present in an amount of from 15 to 45 wt %, for example from 18 to 42 wt %, based on the weight of the linoleum composition. In a particular embodiment, the wood flour is present in an amount of about 40 wt % based on the weight of the linoleum composition. The wood flour typically has a particle size distribution of 40 to 90 wt %, based on total weight of the wood flour, of 80 μm to 160 μm particles and 10 to 50 wt % of less than 80 μm particles. Preferred has a particle size distribution of 50 to 85 wt %, based on total weight of the wood flour, of 80 μm to 160 μm particles and 10 to 30 wt % of less than 80 μm particles.

Other fillers may additionally be present. For example, the linoleum composition may further comprise limestone in an amount of from 5 to 40 wt % based on the weight of the linoleum composition. In a particular embodiment, the limestone is present in an amount of from 5 to 30 wt %, based on the weight of the linoleum composition. In another embodiment, the limestone is present in an amount of from 20 to 30 wt % based on the weight of the linoleum composition. Additional optional fillers include ground cork, ground recycled linoleum, chalk, kaolin, heavy spar, and other known linoleum fillers.

The linoleum composition further comprises a wax. In accordance with the invention, the wax is used to increase the dimensional stability of a linoleum flooring material composed of a linoleum composition comprising the Bedford cement as a binder and the wood flour as a filler. Suitable waxes include natural waxes, e.g., beeswax, and lanolin; mineral waxes, e.g., montan wax; petroleum waxes, e.g., paraffin wax; and synthetic waxes, e.g., polyethylene wax. Paraffin wax is an exemplary wax that is preferred.

The wax is present in an amount effective to provide the wood flour filler with hydrophobic properties. Typically, the wax is present in an amount of from 0.1 to 0.6 wt %, for example from 0.2 to 0.5 wt %, based on the weight of the linoleum composition. In a particular embodiment, the wax is present in an amount of about 0.3 wt % based on the weight of the linoleum composition.

Typically, a preferred wax, for example, paraffin wax, has a congealing point of from 54 to 56° C. measured according to DIN ISO 2207. Optionally, the wax has an oil content of less than or equal to 0.5 wt % measured according to DIN ISO 2908. Optionally, the wax has a penetration of from 16 to 20 measured according to DIN ISO 51579. The wax may provide any combination of these properties. A suitable commercial paraffin wax meeting these properties is available in commerce from Sasol Wax GmbH, Germany, under the trade name Sasolwax 5403.

The linoleum composition may comprise further components or any combination thereof, such as at least one fire retardant, for example aluminium trihydroxide (ATH) in an amount of from 5 to 15 wt % based on the weight of the linoleum composition; one or more pigments in an amount of up to 5 wt % based on the weight of the linoleum composition; and in zinc oxide in an amount of from 0.1. to 1 wt % based on the weight of the linoleum composition. The zinc oxide may function as a pigment. Other alternative optional pigments include titanium dioxide, iron oxide, or other inorganic or organic coloring agents or dyes.

The linoleum composition may also include other additives known for use in linoleum compositions, such as processing agents, antioxidants, UV stabilizers, slip additives and radical initiators.

According to the invention, the linoleum composition is employed to produce a flooring material. During manufacture, the components of the linoleum composition are mixed together to form a mix mass which is substantially homogeneous. All of the components, including at least the Bedford cement, wood filler and paraffin wax, are mixed in a mixing unit such as a kneader, rolling mill or extruder, to form a mix mass matrix. The mix mass is supplied to a rolling mill and, under pressure and elevated temperature, typically from 10 to 150° C., is pressed onto a backing material as a carrier. The pressure and temperature are controlled to provide a desired thickness of the floor covering material, for example from 1.5 to 6 mm. The floor covering material may be in the form of a monolayer or single layer. Alternatively, the floor covering material may be in the form of a multilayer laminate, formed by calendaring or pressing an upper linoleum layer onto a lower linoleum layer/backing material combination.

Typically, the flooring material is a layer element selected from a tile, sheet and web.

Typically, the linoleum composition is carried on a carrier scrim material located at a rear major surface of the flooring layer. The scrim may be composed of fabric composed of natural fibres, such as jute, mixed fabrics of natural fibres, cotton, viscose staple fibre, glass fibers, or another fabric material or mixture of materials. For example, the carrier scrim material comprises a mixture of polymer weft fibres and glass warp fibres. The weft and warp fibres may have a force per unit length ratio within a range of from 5:2 to 5:5, preferably 5:3.5 to 5:4.5. The polymer fibres may comprise at least one of polyester fibres, such as polyethylene terephthalate (PET) fibres.

Optionally, a polyurethane resin layer covers a front major surface of the flooring material. The polyurethane resin layer typically has a thickness of from 10 to 30 microns.

Optionally, the linoleum composition of the flooring material has a thickness of from 1 mm to 6 mm, preferably 1.5 to 5 mm, and more preferably 1.8 to 4 mm.

The linoleum composition may form a monolayer of linoleum in the flooring material.

Alternatively, the linoleum composition may form a multilayer laminate of linoleum in the flooring material. The flooring material may comprise a lower layer of a first linoleum composition and an upper layer of a second linoleum composition. The lower and upper layers are bonded together at an interface therebetween. At least one or both of the lower and upper layers comprises the linoleum composition of the invention.

The first linoleum composition of the lower layer may comprise the linoleum composition of the invention and/or the upper layer of the second linoleum composition may comprise the linoleum composition of the invention.

In one embodiment, the upper layer of the second linoleum composition is substantially free of paraffin wax. In another embodiment, the upper layer of the second linoleum composition comprises the linoleum composition of the invention.

Typically, the lower layer has a thickness of from 0.5 to 3 mm, preferably 0.6 to 2.5 mm, more preferably 0.7 to 2 mm, including the scrim, and the upper layer has a thickness of 0.5 to 4 mm, preferably 0.6 to 3 mm, more preferably 0.7 to 2.5 mm.

In one particular embodiment, a two-layer linoleum flooring material includes a 1.2 mm thick top linoleum layer and a 0.8 mm thick bottom layer. In this embodiment, only the top layer composition comprises paraffin wax and the top layer has a lower Bedford cement content than the bottom layer.

In one embodiment, the top layer may comprise the following linoleum composition (all percentages are by weight based on the total weight of the composition):
wood flour 35-45%, optionally about 40%;
limestone 5-20%;
Bedford cement 30-40%, optionally about 35%;
fire retardant, for example ATH, 5-15%;
pigments 0-5%;
paraffin wax 0-1%, optionally 0.1-0.6%;
zinc oxide (optionally coated with lanolin) 0.1-1%, optionally 0-0.4%; and
reused, ground scrap linoleum 0-10%.

In one embodiment, the bottom layer may comprise the following linoleum composition (all percentages are by weight based on the total weight of the composition):
wood flour 15-30%, optionally 18-23%;
limestone 20-30%;
Bedford cement 30-45%, optionally about 40%;
fire retardant, for example ATH, 5-15%, optionally 8-10%;
pigments 0-2%,
paraffin (Sasolwax 5403) 0-1%;
zinc oxide (optionally coated with lanolin): 0.1-1%, optionally 0.4%; and
reused, ground scrap linoleum 0-30%.

During manufacture of the linoleum composition, in a preferred process the components of each composition are mixed as dry blend and then homogenized in a plurality of, typically 3-4, heated kneaders, which are known in the linoleum manufacturing art as German mixers. The resulting “mix mass” is chopped into small particles and cooled down to a temperature of from 20-30° C.

The resultant mix mass can be used to manufacture linoleum layers either immediately after mixing or after a period ranging from hours to some days.

The mix mass is then subjected to a calendering process to form the linoleum layer(s). The mix mass is heated up to a temperature of from 60-110° C. prior to calendering. The moisture content of the mix mass is typically lower than 0.6 wt %.

The bottom linoleum layer is formed by calendering the bottom layer mix mass onto a scrim layer. In some embodiments, the scrim layer comprises a polyester, e.g., PET, weft fibres/glass warp fibres mixture. The top layer is calendered onto the bottom layer.

The linoleum structure is cured at (typically at a temperature of 80° C. for a period of from 3 to 8 weeks) to increase the tensile strength and compressive strength of the linoleum composition. The curing causes cross-linking of the binder. Water is added to compensate for the shrinkage during curing. The water can be applied through the gas phase, by means of a watered textile interlayer, the linoleum being stored for 4-14 days on a jumbo roll, or directly. The process may be repeated several times to achieve a moisture level in the linoleum of 2.5-3 wt % based on the total weight of the linoleum, which equilibrates with a value of 50 wt % relative humidity (rH) in the air at a temperature of 23° C.

Less water in the linoleum composition may result in curled material, whereas more water or a faster processing may leads to irreversible structure deformation and doming or curl in the linoleum composition.

Thereafter, the linoleum is subjected to a coating step in which, for example, a polyurethane resin (PUR) is applied onto the upper surface of the linoleum at a typical thickness of from 10 to 30 μm and then the polyurethane resin is cured by ultraviolet (UV) radiation. The linoleum is then preferably rolled up into jumbo rolls.

In order to form tiles, the rolls are cut into planks by the use of a punch, ultrasonic or water as a cutting means. The planks are correspondingly cut into tiles. The tiles may be stored in boxes provided with a barrier to moisture.

### EXAMPLES

Embodiments of the present invention will now be described by way of example only with reference to the following non-limiting Examples.

### Example 1

A two-layer linoleum is produced, using the method described hereinabove, to form individual cut tiles, which in this Example had dimensions of 12 inches×12 inches (30.5 cm x 30.5 cm). The top layer was 1.2 mm thick and the bottom layer was 0.8 mm thick. Only the top layer composition contained paraffin wax.

The top layer comprised the following linoleum composition (all percentages are by weight based on the total weight of the composition):
wood flour 35-45%;
limestone 5-20%;
Bedford cement 30-40%
fire retardant, ATH, 5-15%;
pigments 0-5%;
paraffin wax (Sasolwax 5403):0.3%
zinc oxide 0.1-1%; and
reused, ground scrap linoleum 1-10%.

The bottom layer comprised the following linoleum composition (all percentages are by weight based on the total weight of the composition):
wood flour 15-30%;
limestone 20-30%;
Bedford cement 30-45%;
fire retardant, ATH, 5-15%;
pigment 0-2%,
zinc oxide 0.1-1%; and
reused, ground scrap linoleum 0-30%.

Each tile was conditioned in 50% humidity environment at room temperature (23° C.) for a period of 24 hours.

A number of samples of tiles were tested, in accordance with ASTM test EN669, to determine the tile dimensions at the two edges, in either the machine direction (MD) or across the machine direction (AMD), and in the centre of the tile. The resultant three measurements were averaged to provide an average tile dimension in the AMD direction.

The results are shown in Table 1, which shows the relationship between the dimensional stability, in the AMD direction, and paraffin wax content.

In addition, the curl of each tile was measured on a flat steel plate (measured in mm). The average curl was determined for each tile.

The results are shown in Table 1, which shows the relationship between the average 50% curl value and paraffin wax content.

### Example 2

Two-layer linoleum tiles are produced and tested for dimensional stability, in the AMD direction, and average curl, as described above for Example 1. In this Example the top layer included 0.5 wt % paraffin wax, a higher content than in Example 1.

The bottom layer has the same composition as in Example 1. The tiles have the same dimensions as in Example 1.

### Comparative Example 1

Two-layer linoleum tiles are produced and tested for dimensional stability, in the AMD direction, and average curl, as described above for Example 1. In this Example both the top layer as well as the bottom layer included no paraffin wax.

The tiles had the same dimensions as in Example 1.

TABLE 1

| | Average AMD Dimensional | Average |
|---|---|---|
| | Stability (mm) | Curl (mm) |
| Example 1 | 0.0014 | 0.9 |
| Example 2 | 0.0016 | 2.1 |
| Comparative Example 1 | 0.0020 | 1.0 |

Table 1 shows that when the top layer linoleum composition includes paraffin wax in an amount of 0.3 wt % the dimensional stability in the AMD direction is lower than when the top layer linoleum composition is free of paraffin wax. When the top layer linoleum composition includes paraffin wax in an amount of 0.5 wt % the dimensional stability in the AMD direction is also lower than when the top layer linoleum composition is free of paraffin wax.

Table 1 also shows that when the top layer linoleum composition includes paraffin wax in an amount of 0.3 wt % the curl is statistically similar to when the top layer linoleum composition is free of paraffin wax. However, when the top layer linoleum composition includes paraffin wax in an amount of 0.3 wt % the curl is lower than when the top layer linoleum composition includes paraffin wax in an amount of 0.5 wt %.

These results show that a preferred paraffin wax content of from 0.1 to 0.5 wt %, more preferred from 0.2 to 0.4 wt %, yet more preferred about 0.3 wt %, based on the weight of the linoleum composition provides an optimized balance between achieving high dimensional stability and low curling in linoleum compositions comprising wood flour filler.

### Examples 3 and 4

In each Example, a two-layer linoleum was produced, using the method described hereinabove, to form individual cut tiles, which in these Examples also had dimensions of 12 inches×12 inches (30.5 cm×30.5 cm). The top layer was 1.2 mm thick and the bottom layer was 0.8 mm thick. Both the top and bottom layer compositions comprised paraffin wax.

The top and bottom layers comprised the linoleum compositions shown in Table 2 (all percentages are by weight % based on the total weight of the composition).

TABLE 2

| | Example 3 | | Comparative | Comparative | Comparative |
|---|---|---|---|---|---|
| | [% bw] | Example 4 | Example 2 | Example 3 | Example 4 |
| Scrim | PET/fiberglass | PET/fiberglass | PET/fiberglass | PET/fiberglass | PET/fiberglass |
| Wood flour | Top 38.8 | Top 38.87 | Top 38.88 | Top 38.88 | Top 38.87 |
| | Bottom 21.8 | Bottom 21.96 | Bottom 21.96 | Bottom 21.96 | Bottom 21.96 |
| Limestone | Top 14 | Top 3.12 | Top 14.5 | Top 14.5 | Top 14.5 |
| | Bottom 27.5 | Bottom 27.24 | Bottom 27.36 | Bottom 27.75 | Bottom 27.75 |
| Bedford | Top 36 | Top 35.98 | Top 35.98 | Top 35.98 | Top 35.98 |
| cement | Bottom 41 | Bottom 41.04 | Bottom 41.04 | Bottom 41.04 | Bottom 41.04 |
| Fire | Top 9 | Top 9.21 | Top 9.21 | Top 9.21 | Top 9.21 |
| retardant, | Bottom 9 | Bottom 9.1 | Bottom 9.1 | Bottom 9.1 | Bottom 9.1 |
| ATH | | | | | |
| Pigment | Top 2 | Top 3.12 | Top 1.43 | Top 1.43 | Top 1.43 |
| | Bottom 0.5 | Bottom 0.14 | Bottom 0.14 | Bottom 0.14 | Bottom 0.14 |
| Paraffin wax | Top 0.2 | Top 0.2 | Top 0 | Top 0 | Top 0.26 |
| (Sasolwax | Bottom 0.11 | Bottom 0.11 | Bottom 0 | Bottom 0 | Bottom 0 |
| 5403) | | | | | |
| ZnO (coated | Top 0 | Top 0 | Top 0 | Top 0 | Top |
| with lanolin) | Bottom 0 | Bottom 0.4 | Bottom 0.4 | Bottom 0 | Bottom |
| Reused, | Top 0 | Top 0 | Top 0 | Top 0 | Top |
| ground | Bottom 0 | Bottom 0 | Bottom 0 | Bottom 0 | Bottom |
| scrap | | | | | |
| linoleum | | | | | |

The resultant tiles were tested to determine their dimensional stability both in the across machine direction (AMD) and in the machine direction (MD). The weight gain of the tiles after being immersed in water at room temperature (23° C.) for a period of 72 hours was also measured, which indicated absorption of water by the tiles.

The results are shown in Table 3.

TABLE 3

| | Dimensional | | |
|---|---|---|---|
| | stability | Dimensional stability | Weight gain after |
| | (AMD) - % | (MD) - % | watering - % |
| Example 3 | 0.18 | 0.17 | 2.4 |
| (9450) | | | |
| Example 4 | 0.17 | 0.17 | 2.7 |
| (9460) | | | |
| Comparative | 0.27 | 0.21 | 2.7 |
| Example 2 | | | |
| (9410) | | | |
| Comparative | 0.27 | 0.19 | 3.3 |
| Example 3 | | | |
| (9420) | | | |
| Comparative | 0.25 | 0.15 | 2.9 |
| Example 4 | | | |
| (9430) | | | |

These results show that the use of paraffin wax in the linoleum composition can increase the dimensional stability in both the across machine direction (AMD) and in the machine direction (MD) and also the weight gain of the tiles after being immersed in water can be reduced, which indicates reduced absorption of water by the tiles.

1. A linoleum composition comprising:
a binder comprising Bedford cement;
a filler comprising wood flour; and
a wax present in an amount ranging from 0.1 wt. % to 0.5 wt. % based on the weight of the linoleum composition, thereby providing the wood flour filler with hydrophobic properties.

2. The linoleum composition of claim 1, wherein the wax is present in an amount of from 0.2 to 0.4 wt % based on the weight of the linoleum composition.

3. The linoleum composition of claim 1, wherein the wax has a congealing point of from 54 to 56° C.

4. The linoleum composition of any one of claim 1, wherein the wood flour is present in an amount of from 35 to 45 wt % based on the weight of the linoleum composition.

5. The linoleum composition of claim 1, wherein the wood flour has a particle size fraction 80-160 μm: 40-90%, fraction <80 μm 10-50%.

6. The linoleum composition of claim 1, wherein the filler further comprises limestone in an amount of from 5 wt. % to 30 wt. % based on the weight of the linoleum composition.

7. The linoleum composition of claim 1, wherein the Bedford cement is present in an amount of from 30 to 45 wt % based on the weight of the linoleum composition.

8. The linoleum composition of claim 1, further comprising aluminium trihydroxide in an amount of from 5 to 15 wt % based on the weight of the linoleum composition.

9. The linoleum composition of claim 1, further comprising one or more pigments in an amount of up to 5 wt % based on the weight of the linoleum composition.

10. The linoleum composition of claim 1, further comprising zinc oxide in an amount of from 0.1. to 1 wt % based on the weight of the linoleum composition.

11. A flooring material having a front major surface and a rear major surface opposite the front major surface, the flooring material comprising a linoleum composition layer that comprises:
a binder comprising Bedford cement;
a filler comprising wood flour; and
a wax present in an amount ranging from 0.1 wt. % to 0.5 wt. % based on the weight of the linoleum composition.

12. The flooring material of claim 11, wherein the flooring material is a layer element selected from a tile, sheet and web.

13. The flooring material of claim 11 further comprising a carrier scrim located at the rear major surface of the flooring material.

14. The flooring material of claim 13, wherein the carrier scrim comprises material including a mixture of polymer weft fibres and glass warp fibers, the polymer fibres comprising at least one of polyester fibers and polyethylene terephthalate (PET) fibers.

15. The flooring material of claim 11 further comprising a coating applied to the front major surface of the flooring material, the coating comprising a polyurethane resin layer having a thickness ranging from 10 to 30 microns.

16. The flooring material of claim 11, wherein the linoleum composition layer of the flooring material has a thickness ranging from 1 mm to 6 mm.

17. A flooring material having a multi-layer structure comprising a first linoleum composition layer and a second linoleum composition layer, wherein at least one of the first linoleum composition layer and the second linoleum composition layer comprises:
a binder comprising Bedford cement;
a filler comprising wood flour; and
a wax present in an amount ranging from 0.1 wt. % to 0.5 wt. % based on the weight of each of the first or the second linoleum composition layers;
wherein the first linoleum composition layer and the second linoleum composition layers are bonded together at an interface therebetween.

18. The flooring material of claim 17, wherein the first linoleum composition layer comprises the wax and the second linoleum composition layer is substantially free of the wax.

19. The flooring material of claim 17, wherein the first linoleum composition layer has a thickness ranging from 0.5 mm to 3 mm.

20. The flooring material of claim 17, wherein the second linoleum composition layer has a thickness ranging from 0.5 mm to 4 mm.
